(19) United States
(12) Patent Application Publication
(10) Pub. No.: US 2013/0278217 A1
(43) Pub. Date: Oct. 24, 2013

(54) Hand-held computer or game controller charger rest

(71) Applicant: Scott Gray, Wildwood, MO (US)

(72) Inventor: Scott Gray, Wildwood, MO (US)

(21) Appl. No.: 13/506,453

(22) Filed: Apr. 20, 2012

(51) Int. Cl. H02J 7/00

(52) U.S. Cl. 320/114

(57) ABSTRACT

A Handheld Computer or Game Controller Charger Rest Cooler which is a rest for a handheld computer or game controller. The rest has means for charging the battery in the handheld computer or game controller and has means to cool, through the use of a fan, the handheld computer or game controller while the controller rests on the rest.

### BACKGROUND

1. Technical Field of the Invention

This invention is made for the purpose of charging, cooling, and drying off handheld computer or video game controllers. This invention has applications in the computer and video game industries and in every rechargeable electronic handheld computer controller when the controller is placed on a charger or a rest.

2. Prior Art

Electronic handheld controllers are used to control video games and computers. Handheld controllers heat up from internal electrical resistance and from heat from the hand or hands holding the controllers. In addition, hot hands or the hands of excited persons sweat and a handheld controller may become wet and slick from sweat.

Some handheld controllers are wired to the device they control and other handheld controllers are not wired to the device and these handheld controllers control and communicate or send instructions to the device they control through radio waves or other radiation means.

Hot handheld controllers are uncomfortable to hold. Hot handheld controllers cause the hands holding them to sweat. Sweaty hands slip on the handheld controller and wet the surface of the handheld controller. Persons who are excited, such as those playing video games, are also more prone to sweat which means sweaty hands. A sweat covered handheld controller is uncomfortable to hold and the sweat makes the surface of the controller slick which could interfere with accurate manipulation of the handheld controller.

Handheld controllers frequently have rests on which the controller is placed when not in use. Some handheld controllers have an internal battery and the controller connects with the battery charger through the controller's rest.

Prior art is to have no cooling or ventilation fans as part of the handheld controller's rest. Prior art is to wipe the sweat off the handheld controller with a towel or cloth.

### ADVANTAGES OF THE CLAIMED INVENTION

However, the present invention first allows cooling and second allows drying of the handheld controller through a fan or cooling device located in or on the handheld controller's rest.

A fan on or in the handheld controller's rest which blows air over the controller, cools the controller, and dries the controller. The blown air can also be used by the user to cool and dry his hands. This allows more comfortable and accurate use of the handheld controller.

Prior art did not cool nor pass air over the surface of the handheld controller so the controller became hot, sweaty, uncomfortable to hold, and slick from sweat resulting in less enjoyment and in input mistakes caused by the slick handheld, controller exterior.

The present invention cools the controller and causes sweat to evaporate. Thus the present invention allows longer more comfortable and enjoyable use of a handheld controller and by avoiding a sweaty slick exterior and hand, the present invention results in more accurate inputs through the handheld controller.

### SUMMARY OF THE CLAIMED INVENTION

The invention places a fan or cooling system in the handheld video game or computer controller rest or recharging station which cools and dries the handheld controller while it sits on the rest or is recharged.

### DRAWINGS

FIG. 1 is a top view of a first embodiment.

FIG. 2 is a side view of a first embodiment.

FIG. 3 is a side view of a first embodiment.

FIG. 4 is a back view of a first embodiment.

FIG. 5 is a view of the first embodiment with the housing removed.

### LIST OF REFERENCE NUMERALS

102—110 volt ac female electrical cord port or receiver
104—transformer
106—male usb port
108—fan
110—female usb port
112—three position dc switch
114—draw holes
116—exit holes
118—housing
120—raised channel

### DETAILED DESCRIPTION

For the embodiment shown, a stand and charging station (“box”) for resting and charging a handheld controller for a Sony Playstation video game system is in the general shape of a right cuboid box. The dimensions of the box are approximately 4 inches wide, 3.5 inches high, and 6 inches deep. The box is hollow and may be made of plastic or metal with a surface thickness of a quarter inch or less. On the top of the box is a raised channel about an inch wide and one half an inch tall running across the top of the housing, and in the middle of the channel is a male USB port sized to fit and charge the handheld controller for a Sony Playstation video game. The handheld controller connects to the USB port and rests on top of the housing in the raised channel. The stand and charging station has an electrical cord which connects to an American 110 volt alternating current outlet. The electrical cord is connected to a female electrical port or receiver. The electrical cord port or receiver is electrically connected to transformer electrical circuitry to transform the 110 volt AC voltage to the appropriate voltage and to control the voltage and charging rate so that the Sony Playstation controller is properly charged and not overcharged by the USB connection and voltage and current. The electrical circuitry is then electrically connected to the male USB port located on the top of the box. The box has an internal fan mounted on the back of the box. The back side of the box has about a dozen round draw holes, each with a diameter of about 0.25 inch. The internal fan is mounted on the inside side of the back side of the box and is situated so that the axis about which its fan rotates is perpendicular to the back side of the box. The internal fan is mounted so that it blows air forward from the back of the box towards the front of the box. When operating the fan draws air into the box through the rear draw holes. The air passes through the fan and then the air is blown out of the box through the exit holes in the housing. The box has about a dozen exit holes on the top of the box beneath where the controller rests in the depression on the top of the box. Each exit hole is in the shape of an elongated slit about 0.125 inches wide and one inch long. The exit holes are placed so that when the internal fan is operating, air is pulled into the box through the holes on the back side of the box, through the internal fan, out the slit holes on top of the box, and onto the resting handheld controller.

The box has an electrical switch on the side which allows the user to choose: 1) power on for the male usb port on the top of the box with the fan on; 2) power on for the male usb port on top of the box with the fan off; and, 3) power off for the usb port on the top of the box and fan off. A female usb port also may be installed on the side of the box and connected to the internal electrical circuitry to allow electrical devices such as wireless headsets to also be charged from the box.

For the embodiment shown, the charging stand is a hollow box with a fan inside the box. The fan, when on, draws air into the box through draw holes cut into the back of the box. The air passes through the spinning fan blades and is pushed through the box and out several exit holes cut into the top of the box. The air passing through the box cools the interior of the box and cools the electrical circuitry located within the box. The handheld controller for a Sony Playstation may be rested on top of the raised channel in the middle of the box where there is are located nearby exit holes on the top of the box. The air passing through the box is pushed out of the box through the exit holes. The exit holes are placed so that moving air leaving the box hit and pass around the resting controller. The air hitting and passing around the controller cools and dries the handheld controller. The box has an 110 volt ac power cord which leaves the box out the back of the box and is connected to a transformer located within the box which converts the 110 volts ac to the appropriate voltage. The transformer is connected to the male usb port located on the top of the box so that a Sony Playstation controller connected to the male usb port is charged. The box has a three position switch on the side of the box which is wired to control the fan and transformer. The switch's three positions are: 1) fan and transformer off; 2) transformer on and fan off; and, 3) fan on and transformer on. While the handheld controller rests on top of the box, the handheld controller may be cooled, dried, and charged. Air exiting the box may also be directed at the user's hands which serves to cool and dry the user's hands.

### EMBODIMENT

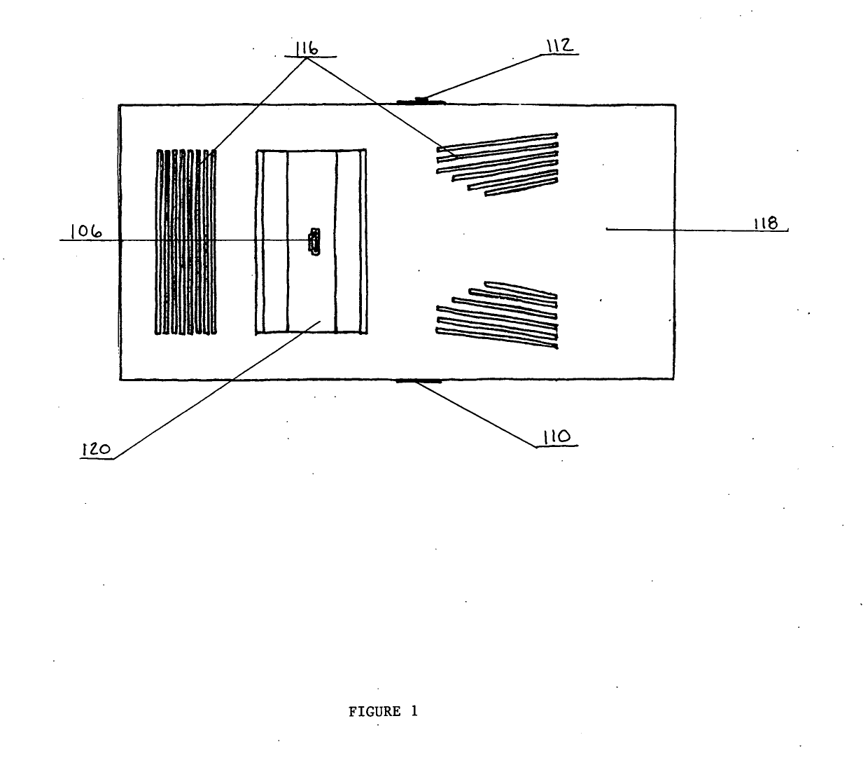

FIG. 1 shows a top view of the first embodiment of the handheld computer or game controller charger rest cooler housing. FIG. 1 shows the raised channel with male usb port in the middle of the channel. FIG. 1 shows the exit holes on the top of the housing for air to be blown out and onto the resting controller and/or the hands of the user. FIG. 1 also shows the switch and usb female port which may be mounted on the sides of the housing.

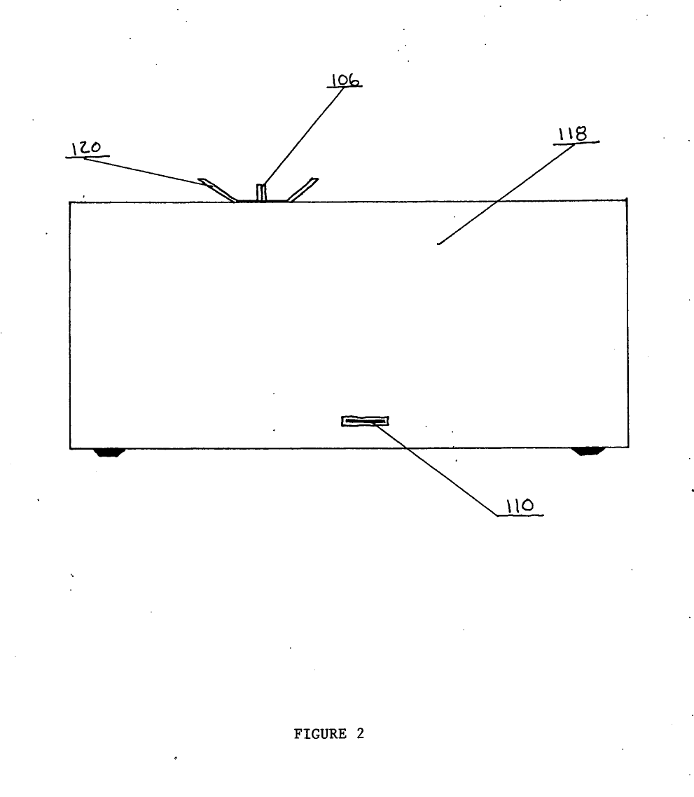

FIG. 2 shows a side view of the handheld controller rest charger with a side view of the raised channel on the top of the housing and a side view of the male usb port located in the center of the raised channel. FIG. 2 also shows the female usb port which may be mounted on one side of the handheld controller charger housing.

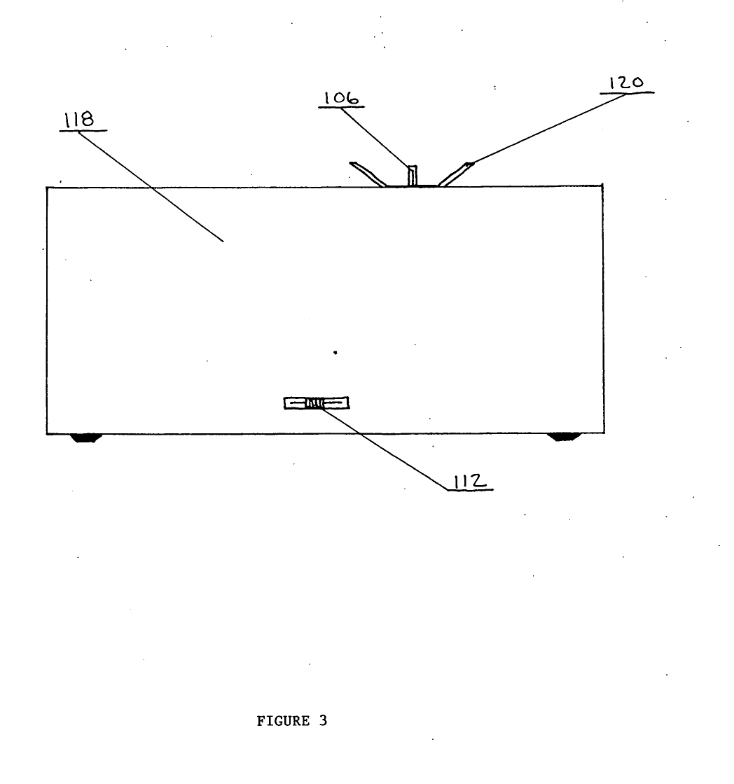

FIG. 3 shows a side view (the opposite side from that shown in FIG. 2) of the handheld controller rest charger housing. FIG. 3 shows the raised channel with male usb port in the middle of the channel. FIG. 3 also shows the three position switch mounted on the side of the handheld controller rest charger housing.

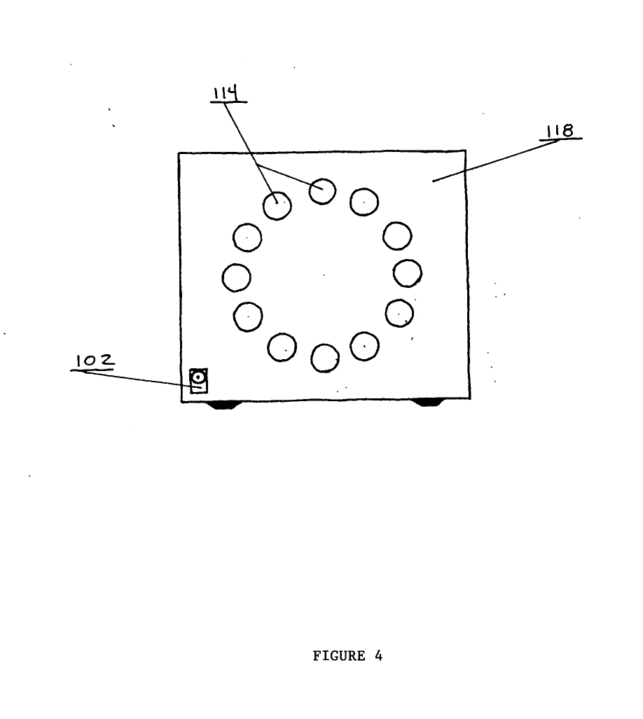

FIG. 4 shows a back view of the handheld controller rest charger housing. FIG. 4 shows the 12 round draw air holes cut into the back of the housing.

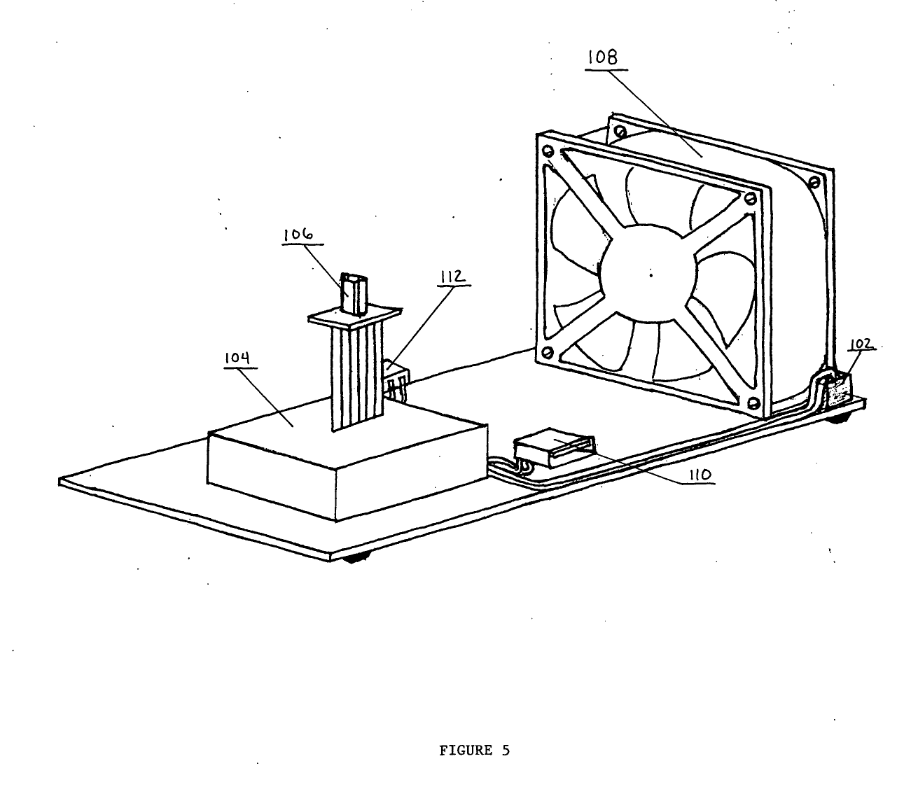

FIG. 5 shows the internal components and layout of the internal components of the handheld controller rest charger with the housing removed. The external 110 volt ac cord connects to the female electrical cord port or receiver. The electrical cord port is electrically connected to the transformer. The transformer is electrically connected to the switch. The internal fan is electrically connected to the transformer. The transformer is also electrically connected to the male usb port and to the female usb port. The fan is mounted at the rear of the handheld game controller charger rest in front of the 12 round draw air holes in the housing.

### CONCLUSION RAMIFICATION AND SCOPE

Thus the reader can see that at least one embodiment of the Handheld Video Game or Computer Controller Rest Cooler:

A. provides cooler and drier handheld controllers;
B. provides cooler and drier hands;
C. allows and encourages more comfortable and accurate operation of a handheld controller; and,
D. allows users to more comfortably use their handheld controllers for longer periods of time without discomfort.

Although the descriptions given above and in the specifications contain many specifics, these should not be construed as limiting the scope of the invention but as merely providing examples and illustrations of some of the several embodiments of the invention. Thus the scope of the invention, should be determined by the appended claims and their legal equivalents, rather than by the examples given in the specifications.

1. A charger for a video game remote controller comprising: a housing with an area upon which a video game remote controller may be placed; means for charging the internal battery of a video game remote controller; and, means for blowing air upon a video game remote controller.

2. A charger for a video game remote controller comprising: a housing with an area upon which a video game remote controller may be placed; a fan located inside the housing with holes in the housing; and, means for charging the internal battery of a video game remote controller.

3. A charger for a video game remote controller comprising: a housing with an area upon which a video game remote controller may be placed; a fan located inside the housing; one or more draw openings in the housing located on the draw side of the fan to allow air to be pulled into the housing by the fan; one or more exit openings in the housing located so that air may be blown by the fan out the exit openings; and, means for charging the internal battery of a video game remote controller.

4. A charger for a video game remote controller comprising: a housing with a rest upon which a video game remote controller may be placed; a fan located inside the housing; one or more draw openings in the housing located on the draw side of the fan to allow air to be pulled into the housing by the fan; one or more exit openings in the housing located so that air may be blown by the fan out the exit openings and hit the resting video game remote controller; and, means for charging the internal battery of a video game remote controller.

5. The charger of claim 1, in which a fan comprises the means for blowing air upon a video game controller.

6. The charger of claim 5, in which a fan mounted inside the housing comprises the means for blowing air upon a video game controller.

7. The charger of claim 6, in which the housing has holes to allow air to be pulled into the housing and holes to allow air to be blown out of the housing by a fan.

8. The charger of claim 7, in which the means for charging the internal battery of a video game controller include a usb port mounted on the housing.

9. A charger for a computer remote controller comprising: a housing with a rest upon which a computer remote controller may be placed; means for charging the internal battery of a computer remote controller; and, means for blowing air upon a computer remote controller.

10. The charger of claim 9, in which the housing has a rest upon which a computer remote controller may be placed.

11. The charger of claim 10, in which a fan located inside the housing and holes in the housing comprise the means for blowing air upon a computer remote controller.

12. The charger of claim 10, in which a fan comprises the means for blowing air upon a computer controller.

13. The charger of claim 10, in which a fan mounted inside the housing comprises the means for blowing air upon a video game controller.

14. The charger of claim 13, in which the housing has holes to allow air to be pulled into the housing and blown out of the housing by a fan.

15. The charger of claim 14, in which the means for charging the internal battery of a computer controller include a usb port mounted on the housing.
